(19) United States
(12) Patent Application Publication
(10) Pub. No.: US 2010/0283366 A1
(43) Pub. Date: Nov. 11, 2010

(54) METHOD OF ROUTING UTILITIES THROUGH AN ARTICULATED HINGE

(75) Inventors: ALAN S. LUCAS, EVANSVILLE, IN (US); HARISH KULKARNI, PUNE (IN)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/437,089

(22) Filed: May 7, 2009

(51) Int. Cl. F25D 23/00; E05D 11/00

(52) U.S. Cl. 312/401; 16/223

(57) ABSTRACT

An articulated hinge allowing non-circular motion of a refrigerator door and having a means for transmitting utilities through the hinge is disclosed. A support rod for preventing torsional deformation of a refrigerator door adapted to carry utilities to an in-door dispenser is also disclosed.

### BACKGROUND OF THE INVENTION

In a refrigerator having a door mounted ice or water dispenser there is a need to transfer utilities, such as water or high or low voltage electricity, from the refrigerator cabinet to the door. In the prior art, utilities are transferred to the door from the refrigerator cabinet in a number of ways, such as through the hinge, through the edge of the door, or adjacent to the hinge. However, the use of articulated hinges which permit the door to open in a non-circular path makes these traditional routing options ineffective or less desirable.

Therefore, a need has been identified in the art to provide a means for routing utilities from a refrigerator cabinet through an articulated hinge and to a door mounted dispenser.

Another recognized area of concern is the potential for a refrigerator door to twist, bend, or otherwise deform as the door is opened on articulated hinges. Therefore, a further need has been identified in the art to provide increased stability for a refrigerator door having articulated hinges.

There is a further concern in refrigerator manufacturing to route utilities to the dispenser from the interface point between the refrigerator cabinet and door. Therefore, a need has been identified in the art to provide a means for routing utilities within the refrigerator door to the dispenser.

### BRIEF SUMMARY OF THE INVENTION

The present invention is directed to transferring utilities from a refrigerator cabinet through an articulated hinge to a refrigerator door with an in-door dispenser. Additionally, an apparatus for routing utilities within the refrigerator door and providing support against torsion forces on the door during opening is disclosed.

According to one preferred embodiment of the present invention, the articulated hinge has a hinge pin attached to the door, the hinge pin having a passage through which utilities may be routed.

According to an alternative embodiment of the present invention, a support rod extends between the top hinge and the bottom hinge, the support rod having a hollow center for carrying utilities towards the door mounted dispenser.

### BRIEF DESCRIPTION OF THE DRAWINGS

FIG. 1A is a perspective view of a refrigerator having a door mounted dispenser and an articulated hinge.

FIG. 1B shows a refrigerator in a fully opened position.

FIG. 2A shows a cutaway view of the hinge demonstrating one embodiment of the present invention.

FIG. 2B shows a cutaway view of the hinge showing an alternative embodiment of the present invention.

FIG. 2C shows a cutaway view of the hinge showing an alternative embodiment of the present invention.

FIG. 3 is an isometric view of the hinge according to the preferred embodiment of the present invention.

FIG. 4 is a cutaway view of the refrigerator door according to one embodiment of the present invention.

### DETAILED DESCRIPTION OF THE PREFERRED EMBODIMENT

The invention relates generally to an improved hinge for use with a refrigerator, the hinge designed to open the refrigerator door in a non-circular path and having features for transmitting utilities through the hinge to a dispenser mounted in the door.

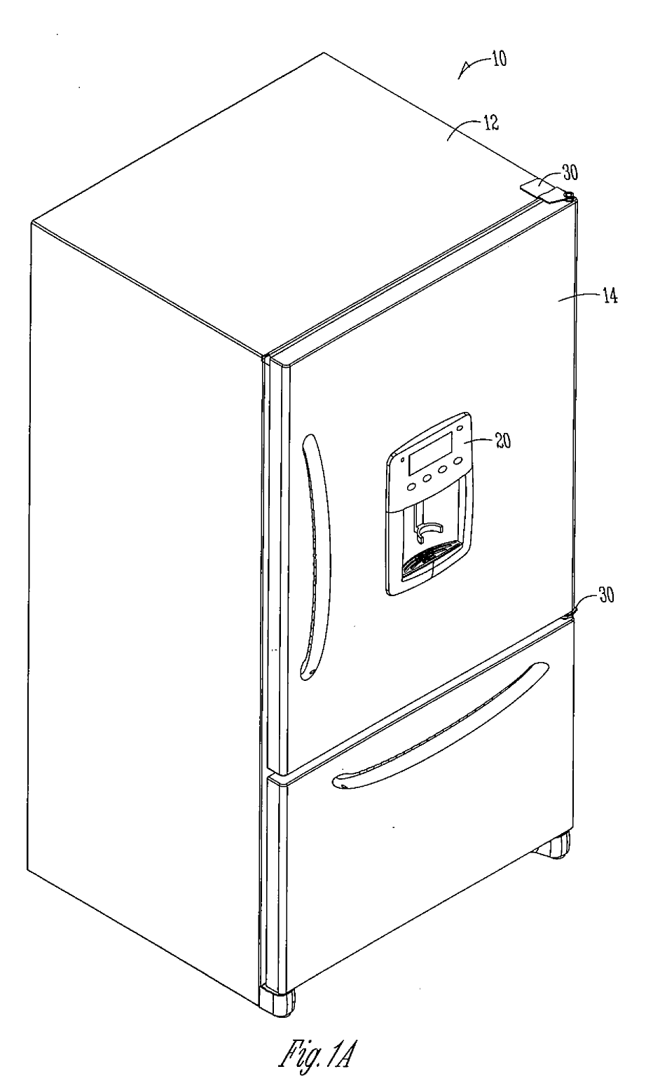

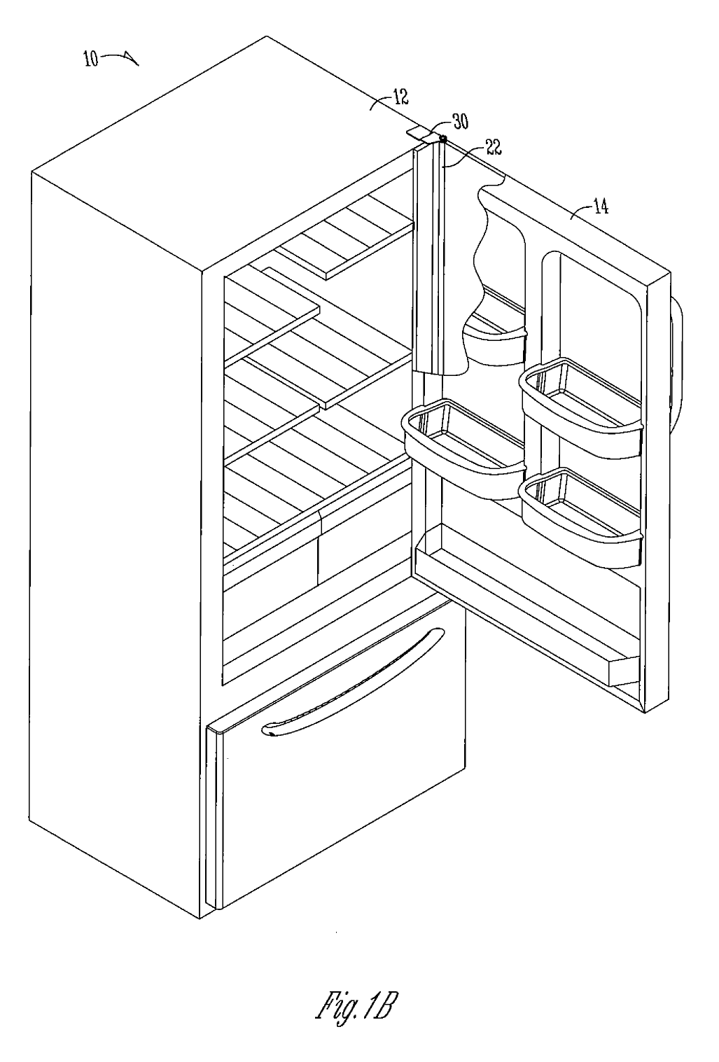

FIG. 1A shows a refrigerator 10 with a refrigerated compartment 12 attached to a door 14 with a hinge 30 located at the top and bottom of the door 14. A dispenser 20 is mounted at a convenient height for a consumer, although the height may vary according to design requirements. The dispenser 20 is preferably designed to selectively dispense ice and water, although other products may be dispensed through the dispenser as is generally known in the art.

FIG. 1B shows the refrigerator door 14 in a fully opened position, providing access to the refrigerated compartment 12. As can be appreciated, the hinges 30 allow the door to be opened in a non-circular path, thereby allowing the refrigerator 10 to be mounted generally flush to and with no obvious gap between adjacent cabinets. The refrigerator as shown in FIGS. 1A and 1B is a top mount refrigerator 10 with a single door 14. However, it should be appreciated by those skilled in the art that the present invention may be utilized with a side-by-side, bottom mount, or other type of refrigerator 10. Additionally, the refrigerated compartment 12 may feature a single door, a pair of French doors, or any configuration generally known in the art.

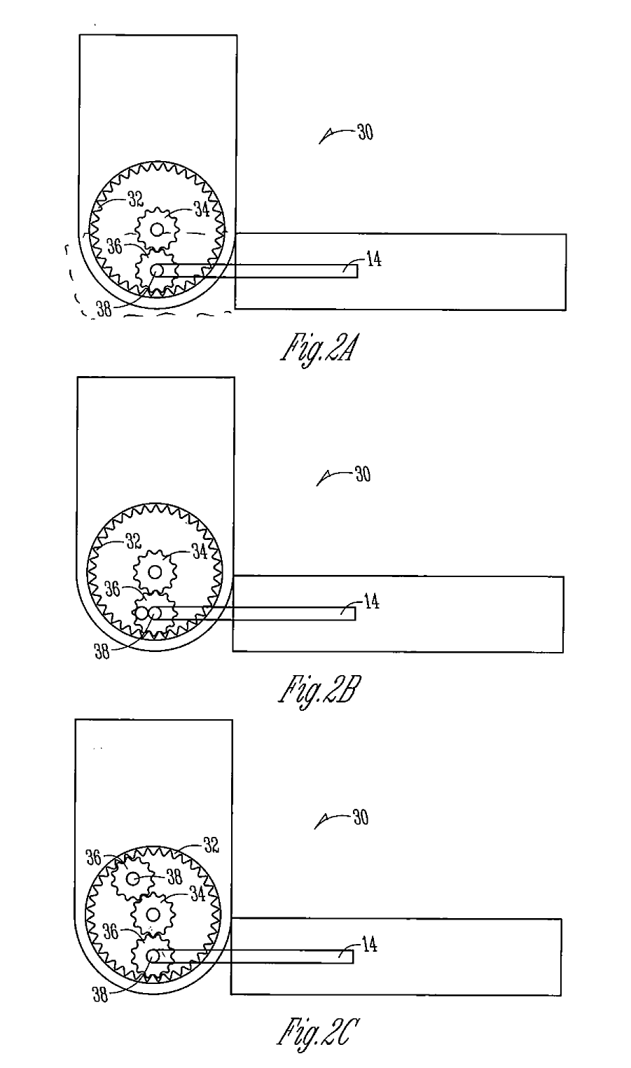

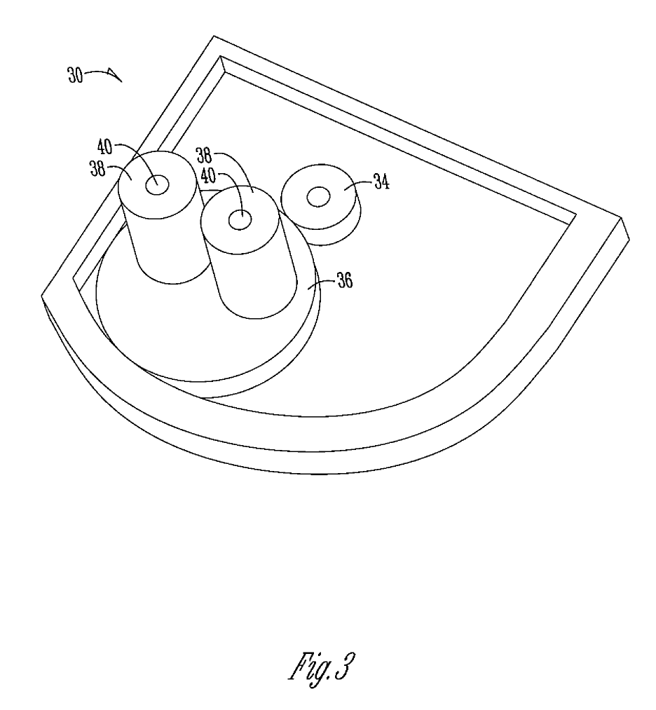

FIGS. 2A-C show a variety of alternative embodiments of the present invention. Generally, the hinge 30 comprises an annulus 32, a sun gear 34, one or more planetary gears 36, and one or more hinge pins 38, at least one of the hinge pins 38 having a passage 40. The door 14 is secured to the hinge pin 38 such that rotational motion of the door 14 is translated to the planetary gear 36. The combination of the annulus 32 and sun gear 34 translate the rotational motion of the planet gear 36 into translational motion about an arc centered on the sun gear 34.

Alternatively, as shown in FIG. 2B, the planet gear 36 may include more than one hinge pin 38. Because the door 14 does not rotate independent of planet gear 36, both hinge pins 38 could be used to route utilities from the refrigerator cabinet 12 through the hinge 30.

As shown in FIG. 2C, a number of planet gears 36 may be used, each having a hinge pin 38. The design of the planetary gear system requires that the distance between the two planet gears 36, and therefore their hinge pins 38, remain the same. Therefore, utilities may be routed through either hinge pin 38 without having to accommodate a change in distance between the two hinge pins 38.

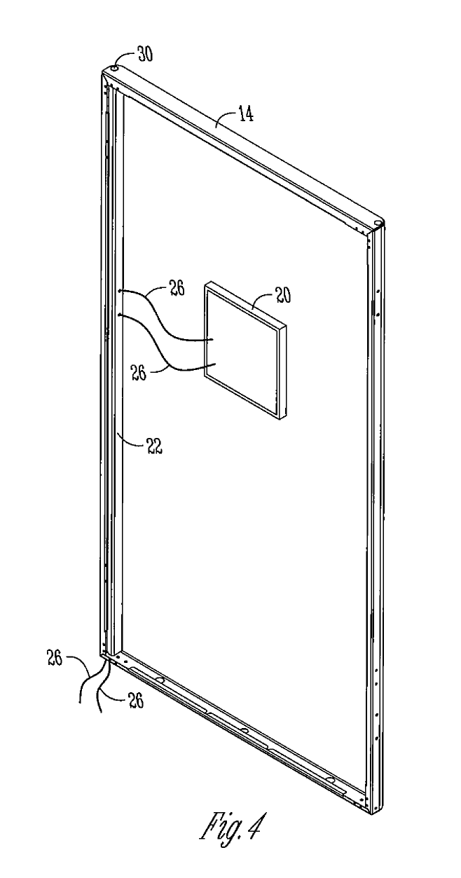

As shown in FIG. 3, the annulus 32 of the hinge 30 may be a partial gear, allowing the refrigerator door 14 to be open only to a predetermined angle. As shown in FIGS. 2A-2C, the annulus 32 may be a complete gear with one or more planet gears 36, each having one or more hinge pins 38 for routing utilities to the door 14.

FIG. 3 is a perspective view of the refrigerator hinge 30, showing the hinge pin 38 and passage 40. The particular embodiment shown in FIG. 3 shows passage 40 as a through hole in hinge pin 38. According to this preferred embodiment, a utility line may be passed through the passage 40 without modification or additional design accommodations. However, hinge pin 38 and passage 40 may take several forms. For example, hinge pin 38 need not be a cylinder, but may be shaped to inhibit rotation of the door 14 about the hinge pin 38. Hinge pin 38 may also be keyed so as to aid in alignment of the planet gear 36 to the door 14 during assembly. Additionally, hinge pin 38 may include geometry for attaching utility supply lines, for example hinge pin 38 may be threaded to accommodate a plumbing fixture. Hinge pin 38 may also include latches or other geometry for receiving a connection for utility transfer. Passage 40 may include functional elements, such as an electrical socket for receiving electrical lines, or a water tight fixture to which water supply lines may be attached.

Additionally, not all utilities supplied to the in-door dispenser 20 need be passed through the hinge 30 or the hinge pin 38. For example, because the distance between the sun gear 34 and the planet gear 36 remains constant, utilities may be passed through the sun gear 34 or other geometry on the sun gear 34. If multiple planet gears 36 are included, the door 14 may be mounted to only one planet gear 36. However, because the distance between any two planet gears 36 is constant, utilities may be routed through one planet gear 36 to the door 14 mounted on another planet gear 36. Additionally, utilities may be passed outside of the hinge, with the utilities having sufficient slack to allow the refrigerator door 14 to fully open.

As shown in FIG. 4, the refrigerator door 14 may also include a support rod 22 for providing resistance against torsion and other bending forces on the door 14. Preferably this support rod 22 extends between two hinges 30 located at the top and bottom of the refrigerator door 14. However, the support rod 22 may be placed elsewhere in the refrigerator, or a plurality of support rods may be placed throughout the refrigerator door 14 according to design and functional requirements. Also as shown in FIG. 4, the support rod 22 may be hollow for receiving utility conduits 26 from the hinge 30 and carrying them towards the dispenser 20. The support rod 22 may feature one or more openings 24 for allowing the conduits 26 to pass out of the support rod 22. According to the preferred embodiment, the conduits 26 travel from the refrigerated compartment 12 through the hinge 30 and into the hollow support rod 22, exiting at the opening 24 and continuing to the dispenser 20. However, additional features may be included on the refrigerator door 14, including but not limited to a docking station, an electrical outlet, a digital readout, lighting, or any other type of fixture, dispenser, appliance commonly known in the art.

According to the preferred embodiment of the present invention, utilities such as water, low voltage electricity or high voltage electricity pass through the hinge 30 to the dispenser 20. Additional utilities may also be passed through the hinge 30 according to design requirements. Such utilities include, but are not limited to, a liquid return line, a liquid additive, pressurized air or other gas, or any utility required to operate a door mounted appliance as known in the art.

The above described embodiments are for illustrative purposes only and do not limit the scope of the claimed invention. The invention is only to be limited by the claims of the patent.

What is claimed is:

1. An articulated hinge in a refrigerator for rotating and translating a door relative to a cabinet having at least one refrigeration compartment therein, the hinge comprising:
a hinge pin incorporated into said articulated hinge for attaching the door to the hinge;
a passage through said hinge pin, said passage adapted to transfer utilities between said cabinet and said door.

2. A hinge connecting a cabinet and a door of a refrigerator, the hinge comprising:
an annulus operatively attached to said cabinet;
a sun gear mounted about a center of the annulus;
a first planet gear engaging said sun gear and annulus, having a first hinge pin attached to said door, said first hinge pin having a passage through which at least one utility is routed.

3. The hinge of claim 2 whereby said hinge further comprises a second planet gear, said second planet gear having a second hinge pin operatively attached to said door, said second hinge pin having a passage through which at least one utility is routed.

4. The hinge of claim 3 whereby said first hinge pin and said second hinge pin carry high and low voltage electric current.

5. The hinge of claim 3 whereby said first hinge pin carries electrical current and said second hinge pin carries water.

6. The hinge of claim 2 whereby said first planetary gear comprises a second hinge pin, said second hinge pin having a passage through which at least one utility is routed.

7. The hinge of claim 6 whereby said first hinge pin and said second hinge pin carry high and low voltage electric current.

8. The hinge of claim 6 whereby said first hinge pin carries electrical current and said second hinge pin carries water.

9. A refrigerator comprising:
a cabinet having at least one refrigeration compartment;
a door providing access to the refrigeration compartment, the door having a top surface and a bottom surface:
a water dispenser mounted to said door;
a top hinge joining the cabinet to the top surface of the door;
a bottom hinge joining the cabinet to the bottom surface of the door; and
a support rod in said door extending between said top hinge and said bottom hinge.

10. The refrigerator of claim 9 whereby said top hinge and said bottom hinge are articulated.

11. The refrigerator of claim 10 whereby said top hinge comprises a top hinge pin and said bottom hinge comprises a bottom hinge pin.

12. The refrigerator of claim 11 whereby at least one of said top and bottom hinge pins comprises a passage for allowing at least one utility to be transferred there through.

13. The refrigerator of claim 12 whereby said support rod comprises a hollow tube through said at least one utility is run from said passage to said dispenser.

14. The refrigerator of claim 13 whereby said door further comprises a plurality of conduits running from said support rod to said water dispenser.

15. The refrigerator of claim 12 wherein said at least one utility comprises water.

16. The refrigerator of claim 12 wherein said at least one utility comprises high and low voltage electricity.
